(19) United States
(12) Patent Application Publication
(10) Pub. No.: US 2015/0020765 A1
(43) Pub. Date: Jan. 22, 2015

(54) COMBUSTION BOWL OF PISTON

(71) Applicant: Electro-Motive Diesel, Inc., LaGrange, IL (US)

(72) Inventors: David A. Pierpont, Dunlap, IL (US); John P. Timmons, Chillicothe, IL (US); Michael B. Goetzke, Orland Park, IL (US); Reddy Pocha Siva Sankara, Lisle, IL (US); Raghavendra Subramanya, Burr Ridge, IL (US)

(21) Appl. No.: 13/945,420

(22) Filed: Jul. 18, 2013

(51) Int. Cl. F02F 3/28

(52) U.S. Cl. CPC F02F 3/28
USPC 123/27 R

(57) ABSTRACT

A piston for a compression ignition internal combustion engine includes a piston body having an outer cylindrical surface defined along a longitudinal piston axis. A piston includes a combustion face defining a combustion bowl including an inner bowl surface, an inner rim portion and an outer rim portion. The combustion face includes a cross-sectional profile of rotation about the longitudinal piston axis. A first profile of the profile of rotation includes a convex curve segment, a linear segment outboard the convex curve segments and a first set of concave curve segments outboard the linear segment. The first set of concave curve segments defines a first radius of curvature. A second profile is provided outboard the first profile and includes a second set of concave curve segments. The second set of concave curve segments defines a second radius of curvature greater than the first radius of curvature.

### TECHNICAL FIELD

The present disclosure relates to a piston of a compression ignition internal combustion engine, and more particularly to a combustion face having a combustion bowl for the piston of the compression ignition internal combustion engine.

### BACKGROUND

Engines including diesel engines, gasoline engines, natural gas engines, and other engines known in the art, may exhaust a complex mixture of air pollutants. The air pollutants may be composed of gaseous compounds, which may include nitrogen oxides (NOx), unburned hydrocarbon, and solid particulate matter such as soot. Due to increased attention to the environment, these exhaust emission needs to be minimized to meet the stringent environmental standards. Therefore, there are many ways in which the amount of air pollutants emitted from an engine may be regulated depending on the type of engine, size of the engine, and/or class of the engine. For example, designs of piston combustion bowl for the engine play an important role in regulating the amount of air pollutants emitted from the engine.

For example, U.S. Pat. No. 7,942,126 relates to a method for operating a direct-injection auto-ignition internal combustion engine and a correspondingly configured internal combustion engine including a piston top having integrally formed therein a piston recess which merges into an essentially annular stepped space and an injector forming injection jets directed toward the stepped space, the jets are deflected there in such a way that a first part quantity of fuel is directed in an axial direction and a radial direction into the piston recess, a second part quantity of fuel is deflected in the axial direction and the radial direction over the piston top and third part quantities of fuel are deflected into a circumferential direction so as to impinge one onto the other in the circumferential direction and to be deflected radially inwardly, the start of injection and the injection duration being coordinated with one another and with the crank angle of the internal combustion engine in such a way that the third part quantities of adjacent injection jets meet each other in the circumferential direction with a velocity of at least 15 m/s.

### SUMMARY

In one aspect, the present disclosure provides a piston for a compression ignition internal combustion engine. The piston includes a piston body having an outer cylindrical surface defined along a longitudinal piston axis. The outer cylindrical surface has a first axial piston end and a second axial piston end. A combustion face is provided at the second axial piston end. The combustion face defines a combustion bowl including a inner bowl surface, an inner rim portion and an outer rim portion. The combustion face includes a cross-sectional profile of rotation about the longitudinal piston axis. The profile of rotation includes a first profile and a second profile. The first profile includes a convex curve segment corresponding to the inner bowl surface and being bisected by the longitudinal piston axis. The first profile further includes a linear curve segment outboard the convex curve segments and a first set of concave curve segments outboard the linear curve segment. The first set of concave curve segments defines a first radius of curvature. The profile of rotation further includes a second profile outboard the first profile which includes a second set of concave curve segments corresponding to the outer rim portion. The second set of concave curve segments defines a second radius of curvature greater than the first radius of curvature.

In another aspect, a compression ignition internal combustion engine is provided. The engine includes a cylinder block defining a plurality of cylinders disposed therein and a cylinder head mounted on the cylinder block. The engine further includes a piston configured to reciprocate within the cylinder block. The piston includes a piston body having an outer cylindrical surface defined along a longitudinal piston axis. The outer cylindrical surface has a first axial piston end and a second axial piston end. A combustion face is provided at the second axial piston end. The combustion face defines a combustion bowl including a inner bowl surface, an inner rim portion and an outer rim portion. The combustion face includes a cross-sectional profile of rotation about the longitudinal piston axis. The profile of rotation includes a first profile and a second profile. The first profile includes a convex curve segment corresponding to the inner bowl surface and being bisected by the longitudinal piston axis. The first profile further includes a linear curve segment outboard the convex curve segments and a first set of concave curve segments outboard the linear curve segment. The first set of concave curve segments defines a first radius of curvature. The profile of rotation further includes a second profile outboard the first profile which includes a second set of concave curve segments corresponding to the outer rim portion. The second set of concave curve segments defines a second radius of curvature greater than the first radius of curvature.

In yet another aspect, a combustion face of a piston for an compression ignition internal combustion engine is provided. The combustion face includes a combustion bowl having an inner bowl surface, an inner rim portion and an outer rim portion. The combustion face includes a cross-sectional profile of rotation about the longitudinal piston axis. The profile of rotation includes a first profile and a second profile. The first profile includes a convex curve segment corresponding to the inner bowl surface and being bisected by the longitudinal piston axis. The first profile further includes a linear curve segment outboard the convex curve segments and a first set of concave curve segments outboard the linear curve segment. The first set of concave curve segments defines a first radius of curvature. The profile of rotation further includes a second profile outboard the first profile which includes a second set of concave curve segments corresponding to the outer rim portion. The second set of concave curve segments defines a second radius of curvature greater than the first radius of curvature.

Other features and aspects of this disclosure will be apparent from the following description and the accompanying drawings.

### BRIEF DESCRIPTION OF THE DRAWINGS

FIG. 1 is a transverse sectional view of an internal combustion engine;

FIG. 2 illustrates a cross-sectional view of a piston having a combustion face, according to an embodiment of the present disclosure; and

FIG. 3 illustrates a detailed diagrammatic view of a profile of the combustion face of the piston of FIG. 2.

### DETAILED DESCRIPTION

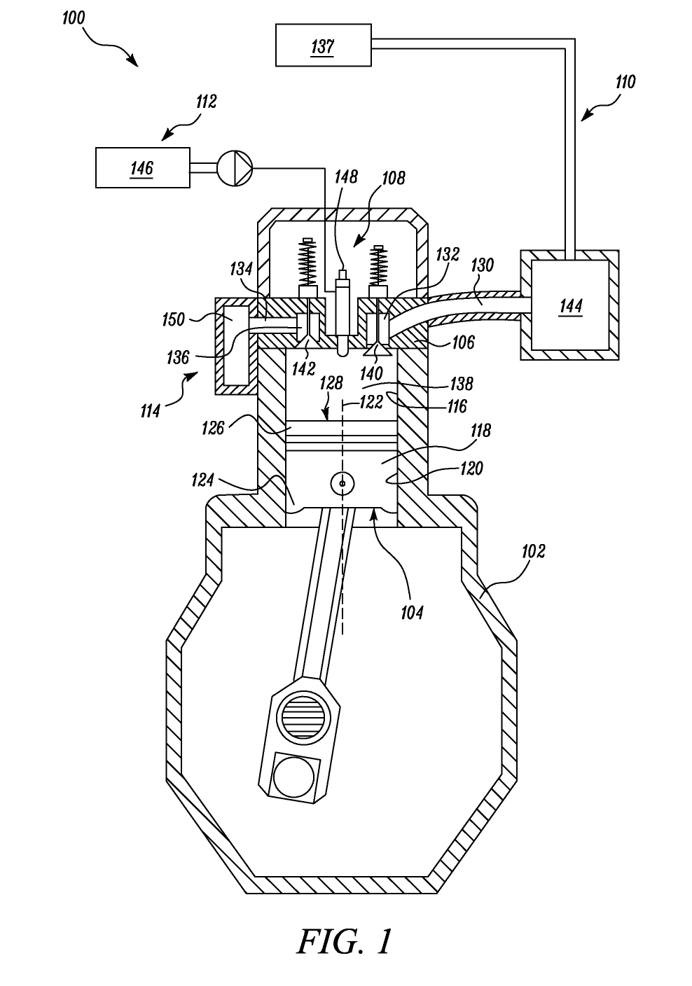

FIG. 1 illustrates a transverse sectional view of an internal combustion engine 100, hereinafter referred to as the engine 100. In an aspect of the present disclosure, the engine 100 may be a direct injection compression ignition internal combustion engine, such as a diesel engine used in locomotives. However, it may be contemplated that the engine 100 may be any other type of direct injection compression ignition internal combustion engine used as a 2-stroke engine or 4-stroke engine. The engine 100 may include an engine block 102, a number of piston assemblies 104 (only one is shown), a cylinder head 106 associated with each piston assembly 104, a valve actuation system 108, an air induction system 110, a fuel system 112 and an exhaust system 114.

The engine block 102 may define a plurality of cylinders 116 (only one is shown). The piston assembly 104 may be positioned to reciprocate within each of the cylinders 116. It is contemplated that the internal combustion engine 100 may include any number of cylinders 116 and that the cylinders 116 may be disposed in an “in-line” configuration, a “V” configuration, or any other conventional configuration.

Each of the piston assembly 104 may be configured to reciprocate between a bottom-dead-center (BDC) position, or lower-most position within the cylinder 116, and a top-dead-center (TDC) position, or upper-most position within the cylinder 116. In particular, the piston assembly 104 may include a piston body 118, including an outer cylindrical surface 120 positioned in opposition to a cylinder wall of the cylinder 116. It will be understood by a person having ordinary skill in the art, that the outer cylindrical surface 120 may not be uniformly cylindrical for a length of the piston body 118, however, it may include a cylindrical surface extending along at least a portion of an axial length which defines a longitudinal piston axis 122. The piston body 118 may further include a first axial piston end 124 and a second axial piston end 126. In an aspect of the present disclosure, the second axial piston end 126 may include a combustion face 128.

Furthermore, each of the cylinder head 106 may be associated with one cylinder 116 to form a combustion chamber 138 having one or more ports. An intake passage 130 may fluidically connect and lead to an intake port 132 for each cylinder 116 and configured to supply air to the cylinder 116. Furthermore, an exhaust passage 134 may fluidically connect and lead to an exhaust port 136 for each cylinder 116. The exhaust passage 134 may be configured to convey a number of combustion products out of the cylinder 116. It may be contemplated that one cylinder head 106 may alternatively be associated with multiple cylinders 116 and piston assemblies 104 to form multiple combustion chambers 138. It may also be contemplated that the cylinder head 106 may further define two or more intake ports 132 and/or exhaust ports 136 for each cylinder 116.

The valve actuation system 108 may include an intake valve 140 disposed within each of the intake port 132 and configured to selectively block the respective intake port 132. Further, an exhaust valve 142 may be disposed within each of the exhaust port 136 and configured to selectively block the respective exhaust port 136.

Furthermore, the air induction system 110 may be configured to draw air 137 into the internal combustion engine 100 and may include an intake manifold 144 fluidically connected with the intake passage 130. It may be contemplated that the air induction system 110 may be a charged air system having a turbine driven or engine driven compressor (not shown), or may include additional air handling components such as, a waste gate valve, a throttle valve, an EGR system, an air cleaner, an air cooler, or any other air handling component known in the art.

The fuel system 112 may be configured to supply fuel to the internal combustion engine 100 and may include a source of pressurized fuel 146 and at least one fuel injector 148. It is contemplated that additional components may be included such as for example, a valve, a common fuel rail configured to distribute fuel to multiple fuel injectors, a pre-combustion chamber, or any other fuel system component known in the art.

The source of pressurized fuel 146 may be configured to produce a flow of pressurized fluid and may include a pump such as, for example, a variable displacement pump, a fixed displacement pump, a variable flow pump, or any other source of pressurized fluid known in the art. The source of pressurized fuel 146 may be drivably connected to a power source (not shown) by, for example, a countershaft (not shown), a belt (not shown), an electrical circuit (not shown), or in any other suitable manner. It is also contemplated that the source of pressurized fuel 146 may alternatively be a supply of pressurized gaseous fuel.

The fuel injector 148 may be disposed within the cylinder head 106 associated with the cylinder 116. The fuel injector 148 may be operable to inject an amount of pressurized fuel into the combustion chamber 138 at predetermined fuel pressures and fuel flow rates. The fuel injector 148 may be mechanically, electrically, pneumatically or hydraulically operated. In an aspect of the present disclosure, the fuel injector 148 may include an upper set of fuel injector orifices and a lower set of fuel injector orifices configured to inject a fuel spray beam at different angles to the combustion face 128.

Furthermore, the exhaust system 114 may be configured to direct exhaust from the cylinder 116 to the atmosphere and may include an exhaust manifold 150 in fluid communication with the exhaust passageway 134 associated with the cylinder 116. It is contemplated that the exhaust system 114 may include other components such as, for example, a turbine, an exhaust gas recirculation system, a particulate filter, a catalytic after treatment system, or any other exhaust system component known in the art.

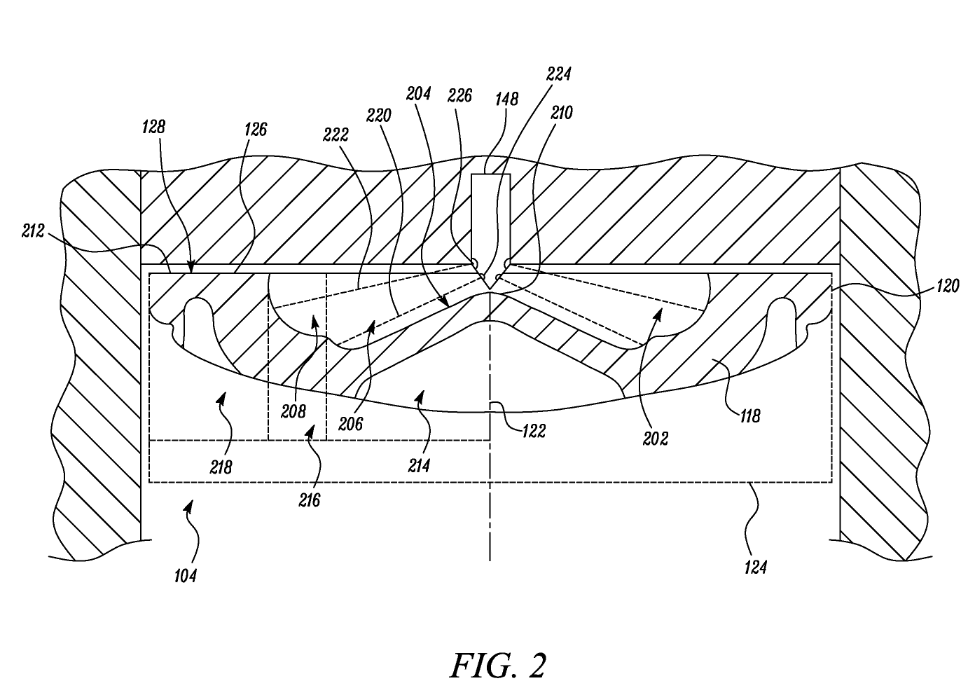

FIG. 2 illustrates a cross-sectional view of the piston 104 in accordance with an embodiment of the present disclosure. As shown in FIG. 2, the second axial piston end 126 may include the combustion face 128 which defines a combustion bowl 202 including an inner bowl surface 204, an inner rim portion 206 and an outer rim portion 208.

In an aspect of the present disclosure, the inner bowl surface 204 may be located on a conical projection 210. The combustion face 128 may further include an outer surface 212 adjacent to the outer cylindrical surface 120 and outboard the outer rim portion 208 of the combustion bowl 202.

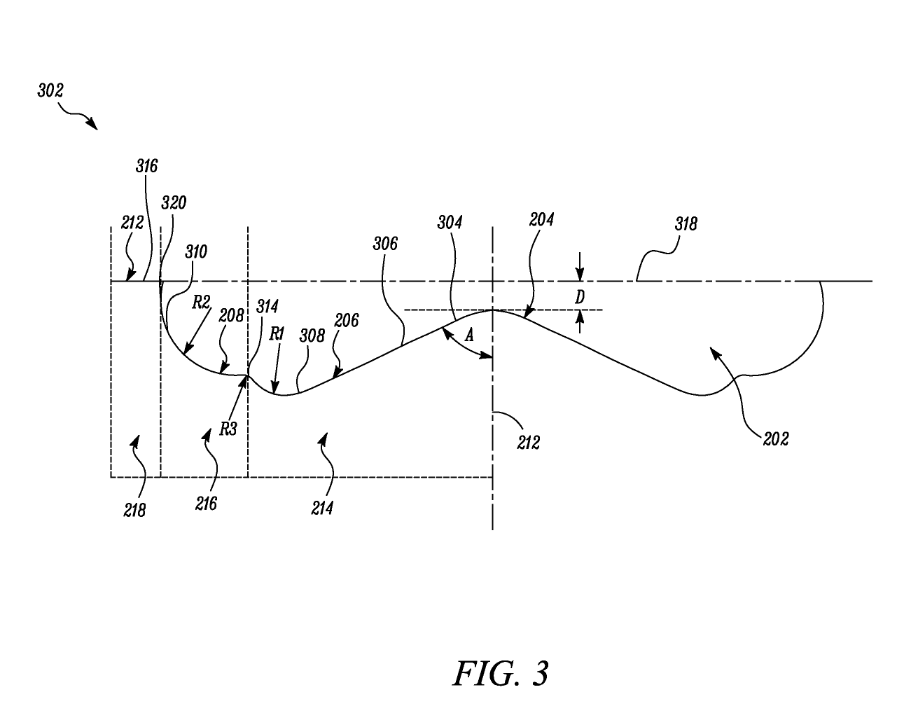

In an aspect of the present disclosure, the combustion face 128 may include a cross-sectional profile which further includes a profile of rotation about the longitudinal piston axis 122. Referring to FIG. 2 and FIG. 3, the profile of rotation of the combustion face 128 may include a first profile 214, a second profile 216 and a third profile 218. The profile of rotation may include a number of curve segments, each corresponding to one of the surfaces of the combustion face 128. The profile of rotation may be radially uniform about the longitudinal piston axis 122. Accordingly, the present description of certain features of the profile of rotation on one side of longitudinal axis 122 as shown in FIG. 2 and FIG. 3 may be understood to refer similarly to features of the profile of rotation on an opposite side of the longitudinal piston axis 122.

The profile of rotation may include a bowl profile 302, as shown in FIG. 3, defining the first profile 214 having a convex curve segment 304 bisected by the longitudinal axis 122. The convex curve segment 304 may correspond to and be defined by the inner bowl 204. Further, the first profile 214 includes a continuous transition having a first linear segment 306 outboard the convex curve segment 304. In an embodiment, the first linear curve segment 306 in disposed at a predetermined angle A from the longitudinal piston axis 122. For example, the predetermined angle A may be within a range of about 60 degrees to 65 degrees.

The first profile 214 may further include a first set of concave curve segments 308 outboard the linear curve segment 306. The first set of concave curve segments 308 correspond to the inner rim portion 206 of the combustion bowl 202. In an aspect of the present disclosure, the first set of concave curve segments 308 defines a first radius of curvature R1.

Furthermore, the profile of rotation may include the second profile 216 outboard the first profile 214. In an aspect of the present disclosure, the second profile 216 may include a second set of concave curve segments 310. The second set of concave curve segments 310 correspond to the outer rim portion 208 of the combustion bowl 202. The second set of concave curve segments 310 may define a second radius of curvature R2. In an aspect of the present disclosure, the second radius of curvature R2 is greater than the first radius of curvature R1. In an exemplary embodiment, the first radius of curvature R1 may be within a range of about 10 mm to 15 mm, and the second radius of curvature R2 may be within a range of about 20 mm to 25 mm.

In an embodiment, the profile of rotation of the combustion face 128 may further include a non-reentrant transition 314 from the first profile 214 to the second profile 216. For example, the non-reentrant transition 314 may be a transition from the first set of concave curve segments 308 to the second set of concave curve segments 310. In an aspect of the present disclosure, the non-reentrant transition 314 is define a third radius of curvature R3 within a range of about 2 mm to 5 mm.

Furthermore, the inner rim portion 206 and the outer rim portion 208 of the combustion bowl 202 are configured to receive two fuel spray beams 220 and 222 respectively from a lower set of fuel injector orifices 224 and an upper set of fuel injector orifices 226 of the fuel injector 148 respectively. In an embodiment, the inner rim portion 206 and the outer rim portion 208 of the combustion bowl 202 are configured to direct the fuel injector beams 220 and 222 at two different planes as shown in FIG. 2.

In an aspect of the present disclosure, the lower set of fuel injector orifices 224 and the upper set of fuel injector orifices 226 may include a first set of fuel injector orifices disposed at a first predetermined angle with respect to each other and a second set of fuel injector orifices disposed at a second predetermined angle with respect to each other. For example, the upper set of fuel injector orifices 226 may include six fuel injector orifices disposed at about 60 degrees with respect to each other around the fuel injector 148. Similarly, the lower set of fuel injector orifices 224 may include six fuel injector orifices disposed at about 60 degrees with respect to each other around the fuel injector 148.

In another aspect of the present disclosure, the upper set of fuel injector orifices 226 and the lower set of fuel injector orifices 224 may inject the fuel spray beams 222 and 220 at different predetermined angles with respect to the longitudinal piston axis 122. In an aspect of the present disclosure, the upper set of fuel injector orifices 226 may have a wider included angle such that the upper set of fuel injector orifices 226 are configured to direct the fuel spray beam 222 onto the outer rim portion 208 of the combustion bowl 202. Further, the lower set of fuel injector orifices 224 may have a narrower included angle such that the lower set of fuel injector orifices 224 may direct the fuel spray beam 220 onto the inner rim portion 206 of the combustion bowl 202. Therefore, these fuel spray beams 220 and 222 are received at two different planes at the inner rim portion 206 and the outer rim portion 208 of the combustion bowl 202 respectively.

The profile of rotation of the combustion face 128 may include the third profile 218 outboard the second profile 216. In an aspect of the present disclosure, the third profile 218 may include a set of linear horizontal segments 316 corresponding to the outer surface 212 adjacent to the outer surface 120. Furthermore, the profile of rotation of the combustion face 128 may include a horizontal axis 318 substantially perpendicular to the longitudinal piston axis 122. In an embodiment, the horizontal axis 318 is configured to pass through the third profile 218 and intersect the second profile 216 at point 320. The horizontal axis 318 is configured to be at a predetermined distance D from the convex curve segment 304 of the first profile 214 of the combustion face 128. In an aspect of the present disclosure, the predetermined distance D is greater than zero.

### Industrial Applicability

Engines including direct injection compression ignition engines such as diesel engines used in locomotives may exhaust a complex mixture of air pollutants. The air pollutants may be composed of gaseous compounds, which may include nitrogen oxides (NOx), unburned hydrocarbon, and solid particulate matter such as soot. Due to increased attention to the environment, these exhaust emission needs to be minimized for meeting the stringent environmental standards. Therefore, there are many ways in which the amount of air pollutants emitted from an engine may be regulated depending on the type of engine, size of the engine, and/or class of the engine.

To regulate the emission of particulate matter, after treatment methods are known. However, these after treatments methods while decreasing the particulate matter emission from the engine, tend to increase the NOx emissions at the same time, which is again not desirable. Therefore, it is important to reduce the generation of the particulate matter during combustion itself without impacting on the NOx emissions.

Accordingly, the piston 104 having the combustion face 128 is disclosed herein. The combustion face 128 includes the combustion bowl 202 having a non-reentrant transition 314 from the inner rim portion 206 to the outer rim portion 208 is configured to divert the fuel spray beams 220 and 222 from the upper set of fuel injector orifices 226 and the lower set of fuel injector orifices 224 into two different planes. This facilitates segregation of the fuel spray fumes and uniform mixing of the fuel spray fumes with in-cylinder charge, such as air in the combustion chamber 138. Uniform mixing of the fuel with the in-cylinder charge results in maximized combustion within the combustion chamber 138 and lower emission of particulate matter, such as soot during combustion.

In an aspect of the present disclosure, the surface area/volume ratio of the combustion bowl 202 having two rim portions, i.e., the inner rim portion 206 and the outer rim portion 208 results in improved heat transfer rate to the surroundings as compared to a single bowl profile. The improved heat transfer rate of the combustion bowl 202 of the present disclosure, results in lower NOx emissions during combustion.

While aspects of the present disclosure have been particularly shown and described with reference to the embodiments above, it will be understood by those skilled in the art that various additional embodiments may be contemplated by the modification of the disclosed engine systems and methods without departing from the spirit and scope of what is disclosed. Such embodiments should be understood to fall within the scope of the present disclosure as determined based upon the claims and any equivalents thereof.

1. A piston for a compression ignition internal combustion engine, the piston comprising:
a piston body including an outer cylindrical surface defined along a longitudinal piston axis, the outer cylindrical surface having a first axial piston end, and a second axial piston end;
a combustion face provided at the second axial piston end, the combustion face defining a combustion bowl having an inner bowl surface, an inner rim portion and an outer rim portion; and
a cross-sectional profile of the combustion face including a profile of rotation about the longitudinal piston axis, the profile of rotation of the combustion face including:
a first profile including a convex curve segment corresponding to the inner bowl surface and being bisected by the longitudinal piston axis, a linear curve segment outboard of the convex curve segment, and a first set of concave curve segments outboard of the linear curve segment and corresponding to the inner rim portion, the first set of concave curve segments defining a first radius of curvature; and
a second profile outboard of the first profile and including a second set of concave curve segments corresponding to the outer rim portion and defining a second radius of curvature greater than the first radius of curvature of the first set of concave curve segments,
the second set of concave curve segments and the first set of concave curve segments connected at a non-reentrant transition, the non-reentrant transition disposed vertically below the convex curve segment.

2. (canceled)

3. The piston of claim 1, wherein the profile of rotation of the combustion face further includes a third profile outboard the second profile and corresponding to an outer surface of the combustion face adjacent to the outer cylindrical surface.

4. The piston of claim 3, wherein the profile of rotation of the combustion face further includes a horizontal axis substantially perpendicular to the longitudinal piston axis and configured to intersect with the third profile and the second profile of the combustion face.

5. The piston of claim 4, wherein the convex curve segment is at a predetermined distance from the horizontal axis, such that the predetermined distance is greater than zero.

6. The piston of claim 1, wherein the linear curve segment is disposed at a predetermined angle from the longitudinal piston axis.

7. The piston of claim 1, wherein the first profile includes a continuous transition from the convex curve segment to the first set of concave curve segments.

8. A compression ignition internal combustion engine comprising:
a cylinder block defining a plurality of cylinders disposed therein;
a cylinder head mounted on the cylinder block;
a piston configured to reciprocate within the cylinder block, the piston including:
a piston body including an outer cylindrical surface defined along a longitudinal piston axis, the outer cylindrical surface having a first axial piston end, and a second axial piston end;
a combustion face provided at the second axial piston end, the combustion face defining a combustion bowl having an inner bowl surface, an inner rim portion and an outer rim portion; and
a cross-sectional profile of the combustion face including a profile of rotation about the longitudinal piston axis, the profile of rotation of the combustion face including:
a first profile including a convex curve segment corresponding to the inner bowl surface and being bisected by the longitudinal piston axis, a linear curve segment outboard the convex curve segment, and a first set of concave curve segments outboard the linear curve segments and corresponding to the inner rim portion, the first set of concave curve segments defining a first radius of curvature; and
a second profile outboard the first profile including a second set of concave curve segments corresponding to the outer rim portion and defining a second radius of curvature greater than the first radius of curvature of the first set of concave curve segments;
the second set of concave curve segments and the first set of concave curve segments connected at a non-reentrant transition, the non-reentrant transition disposed vertically below the convex curve segment; and
a fuel injector having an upper set of fuel injector orifices and a lower set of fuel injector orifices and configured to inject a fuel spray beam at a first angle and a second angle to the outer rim portion and the inner rim portion respectively.

9. (canceled)

10. The engine of claim 8, wherein the profile of rotation of the combustion face further includes a third profile outboard the second profile and corresponding to an outer surface of the combustion face adjacent to the outer cylindrical surface.

11. The engine of claim 10, wherein the profile of rotation of the combustion face further includes a horizontal axis substantially perpendicular to the longitudinal piston axis and configured to intersect with the third profile and the second profile of the combustion face.

12. The engine of claim 11, wherein the convex curve segment is at a predetermined distance from the horizontal axis, such that the predetermined distance is greater than zero.

13. The engine of claim 8, wherein the linear curve segment is disposed at a predetermined angle from the longitudinal piston axis.

14. The engine of claim 8, wherein the first profile includes a continuous transition from the convex curve segment to the first set of concave curve segments.

15. A combustion face of a piston for a compression ignition internal combustion engine, the combustion face comprising;
a combustion bowl having an inner bowl surface, an inner rim portion and an outer rim portion; and
a cross-sectional profile having a profile of rotation about a longitudinal piston axis, the profile of rotation including:
a first profile including a convex curve segment corresponding to the inner bowl surface and being bisected by the longitudinal piston axis, a linear curve segment outboard the convex curve segment, and a first set of concave curve segments outboard the linear curve segments and corresponding to the inner rim portion, the first set of concave curve segments defining a first radius of curvature; and
a second profile outboard the first profile including a second set of concave curve segments corresponding to the outer rim portion and defining a second radius of curvature greater than the first radius of curvature of the first set of concave curve segments,
the second set of concave curve segments and the first set of concave curve segments connected at a non-reentrant transition, the non-reentrant transition disposed vertically below the convex curve segment.

16. (canceled)

17. The combustion face of claim 15, wherein the profile of rotation further includes a third profile outboard the second profile and corresponding to an outer surface of the combustion face adjacent to the outer cylindrical surface.

18. The combustion face of claim 17, wherein the profile of rotation further includes a horizontal axis substantially perpendicular to the longitudinal piston axis and configured to intersect the third profile and the second profile.

19. The combustion face of claim 18, wherein the convex curve segment is at a predetermined distance from the horizontal axis, such that the predetermined distance is greater than zero.

20. The combustion face of claim 15, wherein the first profile includes a continuous transition from the convex curve segment to the first set of concave curve segments.
